(19) United States
(12) Patent Application Publication
(10) Pub. No.: US 2021/0224646 A1
(43) Pub. Date: Jul. 22, 2021

(54) METHOD FOR GENERATING LABELED DATA, IN PARTICULAR FOR TRAINING A NEURAL NETWORK, BY IMPROVING INITIAL LABELS

(71) Applicant: Robert Bosch GmbH, Stuttgart (DE)

(72) Inventors: Achim Feyerabend, Heilbronn (DE); Alexander Blonczewski, Erdmannhausen (DE); Christian Haase-Schuetz, Fellbach (DE); Elena Pancera, Ilsfeld (DE); Heinz Hertlein, Erlenbach (DE); Jinquan Zheng, Frankfurt Am Main (DE); Joscha Liedtke, Ludwigsburg (DE); Marianne Gaul, Marburg (DE); Rainer Stal, Sindelfingen (DE); Srinandan Krishnamoorthy, Untergruppenbach (DE)

(21) Appl. No.: 17/129,393

(22) Filed: Dec. 21, 2020

(30) Foreign Application Priority Data
Dec. 23, 2019 (DE) 102019220522.4
Jan. 16, 2020 (DE) 102020200503.6

(51) Int. Cl. G06N 3/08; G06F 16/23

(52) U.S. Cl. CPC G06N 3/08; G06F 16/2379

(57) ABSTRACT

A method for generating labels for a data set. The method includes: providing an unlabeled data set comprising a number of unlabeled data; generating initial labels for the data of the unlabeled data set; providing the initial labels as nth labels where n=1; performing an iterative process, where an nth iteration of the iterative process comprises the following steps for every n=1, 2, 3, . . . N: training a model as an nth trained model using a labeled data set, the labeled data set being given by a combination of the data of the unlabeled data set with the nth labels; predicting nth predicted labels for the unlabeled data of the unlabeled data set by using the nth trained model; determining (n+1)th labels from a set of labels comprising at least the nth predicted labels.

### CROSS REFERENCE

The present application claims the benefit under 35 U.S.C. § 119 of German Patent Application No. 102019220522.4 filed on Dec. 23, 2019, and German Patent Application No. DE 102020200503.6 filed on Jan. 16, 2020, both of which are expressly incorporated herein by reference in their entireties.

### FIELD

The present invention relates to a method for generating labels for a data set and to a use of the method for generating training data for training a model, in particular a neural network.

### BACKGROUND INFORMATION

Methods of machine learning, in particular of learning using neural networks, in particular deep neural networks (DNN), are superior to classical non-trained methods for pattern recognition in the case of many problems. Almost all of these methods are based on supervised learning.

Supervised learning requires annotated or labeled data as training data. These annotations, also called labels below, are used as the target output for an optimization algorithm. For this purpose, at least one label is assigned to each data element.

The quality of the labels may affect the recognition performance of the trained models of the machine learning methods. Conventionally, samples are labeled manually for the training of machine learning methods.

The present invention provides a method for generating labels that is improved compared to the related art.

### SUMMARY

One specific embodiment of the present invention relates to a method for generating labels for a data set, the method comprising: providing an unlabeled data set comprising a number of unlabeled data;

generating initial labels for the data of the unlabeled data set;

providing the initial labels as nth labels where n=1;

performing an iterative process, where an nth iteration of the iterative process comprises the following steps for every n=1, 2, 3, . . . N: training a model as an nth trained model using a labeled data set, the labeled data set being given by a combination of the data of the unlabeled data set with the nth labels; predicting nth predicted labels for the unlabeled data of the unlabeled data set by using the nth trained model; determining (n+1)th labels from a set of labels comprising at least the nth predicted labels.

Starting from initial labels, the method is based on improving these initial labels and to generate further labels and to improve the labels, in particular a quality of the labels, step-by-step in an iterative method. The capacity of trained models for generalization and/or the increasing accuracy of the trained model over the iterations are utilized for this purpose.

The labels generated by the method may be provided together with the data set as labeled, or annotated, training data for training a model, in particular a neural network.

The unlabeled data of the unlabeled data set are for example real data, in particular measured values from sensors, in particular multi-modal data. According to an exemplary, incomplete list, these sensors may be radar sensors, optical cameras, ultrasonic sensors, lidar sensors or infrared sensors, for example. Such sensors are usually used in autonomous and partially autonomous functions in motor vehicles or generally in robots.

Initial labels are generated for the at first still unlabeled data. One advantage of the example method in accordance with the present invention is that a faulty generation of the label suffices in this step. Hence it is possible to implement the generation of the labels in a comparatively simple fashion and thus relatively quickly and cost-effectively.

The initial labels are then used as first labels in a first iteration of an iterative process, the following steps being performed in an iteration of the iterative process.

In one step of the first iteration, the model is trained using a labeled data set from a combination of the data of the unlabeled data set with the initial labels as a first trained model. In a further step of the iteration, first predicted labels are predicted for the unlabeled data set by using the first trained model. In a further step, second labels are determined from a set of labels comprising at least the first predicted labels. The step for determining the labels advantageously serves to improve the labels. Generally, a suitable selection of the best possible currently existing labels is made or a suitable combination or fusion of the currently existing labels is performed in order to determine the labels for the training of the next iteration.

The second labels are then used in the second iteration for training the model as the second trained model.

A further specific embodiment provides for the set of labels, from which the (n+1)th labels are determined, to comprise the predicted labels and further then nth labels. The determination of (n+1)th labels in the nth iteration is then performed on the basis of the set comprising the nth labels and the nth predicted labels in this iteration.

Another specific embodiment provides for the steps of the iterative process to be performed repeatedly for as long as a quality criterion and/or termination criterion is not yet fulfilled. A quality criterion comprises for example the quality of the generated labels or a prediction quality of the model. A termination criterion comprises for example the exceeding or undershooting of a threshold value, in particular a number of iterations to be performed or a value for the change of the labels from one iteration to the next or a quality measure for the labels. The assessment of the quality of the labels and/or of the prediction quality may be performed for example on the basis of a labeled reference sample of good quality. Alternatively, the quality may be assessed on the basis of confidences of the model, which are output in addition to the predicted labels.

Another specific embodiment of the present invention provides for the determination of (n+1)th labels to comprise the determination of optimal labels. The determination may be performed automatically for example using an algorithm. For this purpose, in particular the nth labels and the nth predicted labels, and possibly the initial labels, are compared to one another, and the best currently existing labels are selected. Alternatively, a manual method for determining optimal labels is also possible.

Another specific embodiment of the present invention provides for the generation of the initial labels for the unlabeled data to be performed manually or by a pattern recognition algorithm. Since a faulty generation of the labels suffices in this step, it is possible to implement the generation in a comparatively simple manner and thus relatively quickly and cost-effectively. This may be done automatically for example by a classical non-trained pattern recognition algorithm, in particular with a recognition imprecision. In particular, it is also possible to use a method trained on another data set without adaptation to the current data set. Manual labeling is in principle also possible.

In order to improve the generalization of the trained model during the iterative process and to avoid systematic errors being learned in the initial labels, it is in particular also possible initially to refrain from using a portion of the information of the data of the unlabeled data set in particular at the beginning of the iterative process. In particular, it may be expedient initially not to use information such as is essential for generating the initial labels using the non-trained pattern recognition algorithm. In the further course of the iterative process, the information that is initially not used may eventually be used. An example of this is the use of color information in images for generating the initial labels, where the color information is initially not provided in the iterative process, that is, the original color images are converted into gray-tone images. The color information may be added in the further course of the iterative process, it then being possible to adapt the architecture of the trainable model accordingly in order to process the additional information, for example the color images instead of the gray-tone images.

Another specific embodiment of the present invention provides for the set of labels to comprise the initial labels. The determination of (n+1)th labels in the nth iteration is then performed on the basis of a set comprising the initial labels and the nth predicted labels in this iteration and possibly the nth labels.

Another specific embodiment of the present invention provides for the method to comprise further: discarding data of the unlabeled data set, in particular prior to training the model. The discarded data are then no longer taken into consideration in the current iteration and in particular also in further iterations. In particular, data may be discarded for which a respective nth predicted label deviates from a respective nth label.

Another specific embodiment of the present invention provides for the determination of (n+1)th labels to comprise the calculation of an, in particular weighted, average value of labels from the set of labels.

In the course of the iterations, the weights may be advantageously changed in such a way that with an increasing number of iterations the labels predicted by the model increasingly have a greater share and the initial labels increasingly have a lesser share in the (n+1)th labels. This procedure may be applied in particular in a regression problem.

Another specific embodiment of the present invention provides for the method to comprise further: determining weights for training the model and/or using weights for training the model. The weights are advantageously determined in every iteration. The determination of the weights comprises for example deriving the weights from a measure for the confidence of the trained model for the respective data of the unlabeled data set and/or from a measure for the confidence of the classical model for the respective data of the data set. It is advantageously possible to achieve the result that erroneously labeled data have a lesser effect on the recognition rate of the trained model. As an alternative or in addition to the confidences, it is also possible to perform a comparison of the labels and to include this in the determination of the weights.

Another specific embodiment of the present invention provides for steps of the method to be carried out, in particular for predicting nth predicted labels for the unlabeled data of the unlabeled data set by using the nth trained model and/or for determining (n+1)th labels from a set of labels comprising at least the nth predicted labels by using at least one further model. In connection with this specific embodiment, there may be a provision for the model to be part of a system for object recognition, and in particular for localization, abbreviated below as recognition system, comprising the at least one further model. Advantageously, in the case of time-dependent data, it is possible for example that the time correlation and/or continuity conditions of a suitable model of the recognition system, in particular a movement model, are used for carrying out steps of the method. Furthermore, an embedding of the model in a recognition system including time tracking, in particular by using classical methods, for example Kalman filtering, may also prove advantageous. Furthermore, an embedding of the model in offline processing may prove advantageous, in which case not only measurement data from the past, but also from the future are included at a certain time in the generation of the labels. It is thus advantageously possible to improve the quality of the labels. Furthermore, an embedding of the model in a recognition system or fusion system, which works on multimodal sensor data and consequently has additional sensor data available, may also prove advantageous.

Another specific embodiment of the present invention provides for the method to comprise further: increasing a complexity of the model. There may be a provision to increase the complexity of the model in every iteration n, n=1, 2, 3, . . . N. Advantageously it may be provided that at the beginning of the iterative process, that is, in the first iteration and in a certain number of further iterations relatively at the beginning of the iterative process, a model is trained, which is simpler with respect to the type of mathematical model and/or with respect to the complexity of the model and/or which contains a smaller number of parameters to be estimated within the scope of the training. It may then be further provided that in the course of the iterative process, that is, after a certain number of further iterations of the iterative process, a model is trained, which is more complex with respect to the type of mathematical model and/or more complex with respect to the complexity of the model and/or which contains a greater number of parameters to be estimated within the scope of the training.

A further specific embodiment of the present invention relates to a device, the device being designed to implement a method in accordance with the specific embodiments.

A further specific embodiment of the present invention provides for the device to comprise a computing device and a storage device, in particular for storing a model, in particular a neural network.

Another specific embodiment of the present invention provides for the device to comprise at least one further model, the further model being developed as part of a system for object recognition.

The example method is particularly suitable for labeling data recorded by sensors. The sensors may be cameras, lidar sensors, radar sensors, ultrasonic sensors, for example. The data labeled using the method are preferably used for training a pattern recognition algorithm, in particular an object recognition algorithm. By way of these pattern recognition algorithms, it is possible to control various technical systems and to achieve for example medical advances in diagnostics. Object recognition algorithms trained using the labeled data are especially suitable for use in control systems, in particular driving functions, in at least partially automated robots. These may thus be used for example for industrial robots in order specifically to process or transport objects or to activate safety functions, for example a shut down, based on a specific object class. For automated robots, in particular automated vehicles, such object recognition algorithms may be used advantageously for improving or enabling driving functions. In particular, based on a recognition of an object by the object recognition algorithm, it is possible to perform a lateral and/or longitudinal guidance of a robot, in particular of an automated vehicle. Various driving functions such as emergency braking functions or lane-keeping functions may be improved by using these object recognition algorithms.

Another specific embodiment of the present invention relates to a computer program, the computer program comprising computer-readable instructions, a method according to the specific embodiments being implemented when the instructions are executed by a computer.

A further specific embodiment of the present invention relates to a computer program product, the computer program product comprising a computer-readable storage medium, on which a computer program according to the specific embodiments is stored.

Another specific embodiment of the present invention relates to a use of a method according to the specific embodiments and/or of a device according to the specific embodiments and/or of a computer program according to the specific embodiments and/or of a computer program product according to the specific embodiments for generating training data for training a model, in particular a neural network.

Another specific embodiment of the present invention relates to a use of labels for a data set, the labels having been generated using a method according to the specific embodiments and/or using a device according to the specific embodiments and/or using a computer program according to the specific embodiments and/or using a computer program product according to the specific embodiments, in training data comprising the data set for training a model, in particular a neural network.

Additional features, application options and advantages of the present invention result from the following description of exemplary embodiments of the present invention, which are shown in the figures. For this purpose, all of the described or illustrated features form the subject of the present invention, either alone or in any combination, irrespective of their combination, formulation or representation in the description or in the figures.

### BRIEF DESCRIPTION OF THE DRAWINGS

FIG. 1 shows a schematic representation of steps of a method in a flow chart in accordance with an example embodiment of the present invention.

FIG. 2a shows a schematic representation of a method according to a first preferred specific embodiment of the present invention in a block diagram according to a first preferred specific embodiment of the present invention.

FIG. 2b shows an alternative schematic representation of the method from FIG. 2a in a block diagram, in accordance with an example embodiment of the present invention.

FIG. 3 shows a schematic representation of a method according to another preferred specific embodiment of the present invention in a block diagram.

FIG. 4 shows a schematic representation of a method according to another preferred specific embodiment of the present invention in a block diagram.

FIG. 5 shows a device according to a preferred specific embodiment of the present invention in a simplified block diagram.

### DETAILED DESCRIPTION OF EXAMPLE EMBODIMENTS

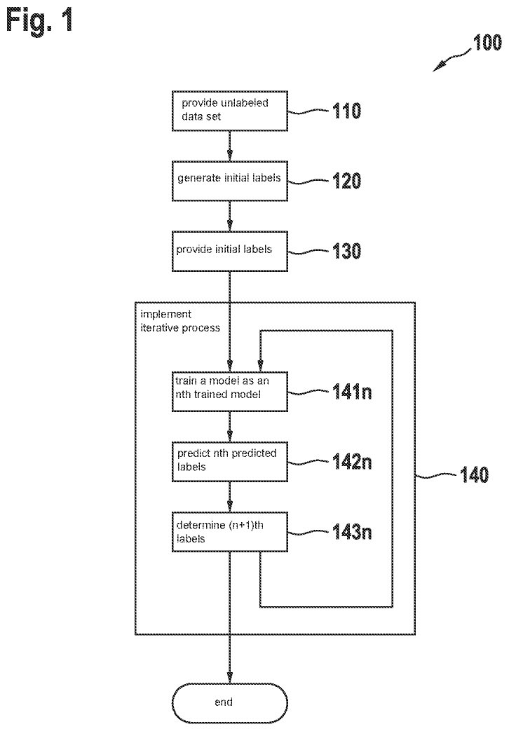

FIG. 1 shows a schematic representation of steps of a method 100 for generating labels L for a data set D. The method 100 comprises the following steps:

a step 110 for providing an unlabeled data set D comprising a number of unlabeled data;

a step 120 for generating initial labels L1 for the data of the unlabeled data set D;

a step 130 for providing the initial labels L1 as nth labels Ln where n=1, it being possible to provide a labeled data set D_Ln by combining the unlabeled data set D with the nth labels Ln;

a step 140 for implementing an iterative process, an nth iteration of the iterative process comprising the following steps for every n=1, 2, 3, . . . N:

training 141n a model M as an nth trained model Mn using a labeled data set D_Ln, the labeled data set D_Ln being given by a combination of the data of the unlabeled data set D with the nth labels Ln;

predicting 142n nth predicted labels Ln′ by using the nth trained model Mn for the unlabeled data set D, the labeled data set D_Ln′ being created in the process;

determining 143n (n+1)th labels Ln+1 from a set of labels comprising at least the nth predicted labels Ln′.

The step 143n for determining the labels Ln+1 advantageously serves to improve the labels. Generally, a suitable selection of the best possible currently existing labels is made or a suitable combination or fusion of the currently existing labels is performed in order to determine the labels for the training of the next iteration.

The unlabeled data of the unlabeled data set D are for example real data, in particular measured values from sensors, in particular multi-modal data. According to an exemplary incomplete list, these sensors are for example radar sensors, optical cameras, ultrasonic sensors, lidar sensors or infrared sensors. These sensors are usually used in autonomous and partially autonomous functions in motor vehicles or generally in robots.

For the at first still unlabeled data of data set D, initial labels L1 are generated in step 120. A faulty generation of labels L1 suffices in this step. Starting from the initial labels L1, further labels are generated and iteratively improved in the course of the method. Hence it is possible to implement the generation 120 of the initial labels L1 in a comparatively simple fashion and thus relatively quickly and cost-effectively.

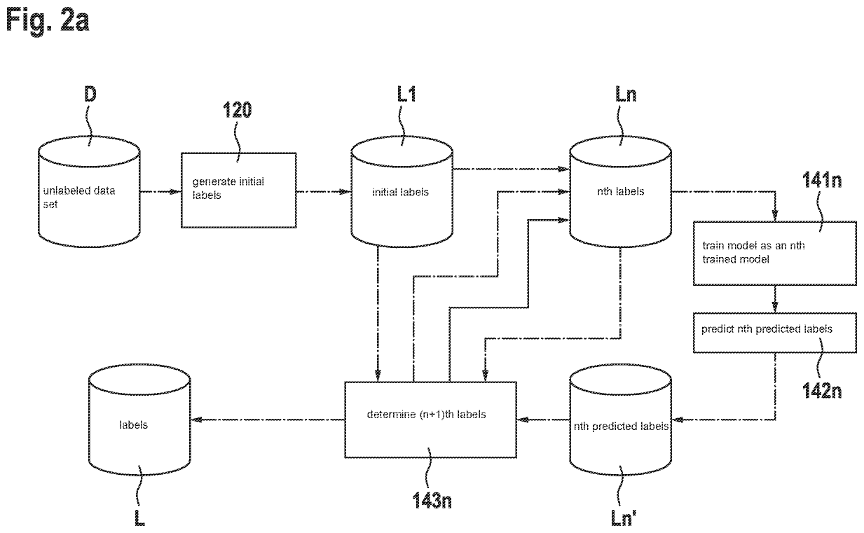

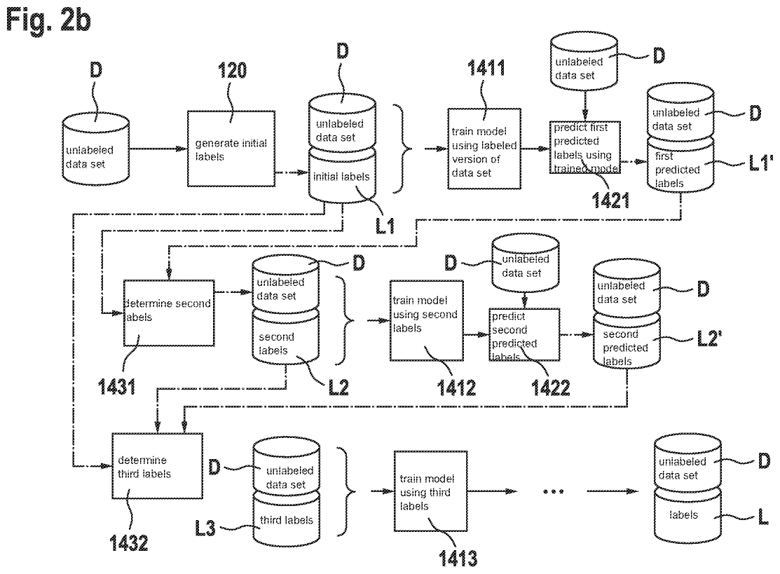

A first specific embodiment of the method is explained with reference to FIGS. 2a and 2b, FIG. 2b being an alternative representation of FIG. 2a. Steps of the method are shown schematically as rectangles, data in the form of data set D and of the labels are shown as cylinders, transitions between the individual steps and data are shown as arrows, and data flows are shown as dashed arrows.

In step 120, initial labels L1 are generated for the data of unlabeled data set D. The combination of these initial labels L1 with data set D produces the labeled version of data set D_L1.

The initial labels L1 are then used as first labels Ln with n=1 in the first iteration of the iterative process. The following steps are performed in the first iteration of the iterative process:

In step 1411 of the first iteration, the model M is trained using labeled data set D_L1, produced by combining the unlabeled data set D and the initial labels L1, as a first trained model M1.In step 1421 of the first iteration, first predicted labels L1′ are predicted for unlabeled data set D by using the first trained model M1. In step 1431, second labels L2 are determined from the set of labels comprising at least the first predicted labels L1′.

The second labels L2 are then used in the second iteration of the iterative process for training 1412 the model M as the second trained model M2.

In step 1422 of the second iteration, second predicted labels L2′ are predicted for unlabeled data set D by using the second trained model M2. In step 1432, third labels L3 are determined from the set of labels comprising at least the second predicted labels L2′.

One specific embodiment provides for the set of labels, from which the (n+1)th labels Ln+1 are determined, to comprise the predicted labels Ln′ and furthermore then nth labels Ln. The determination of (n+1)th labels in the nth iteration is then performed on the basis of the set comprising the nth labels Ln and the nth predicted labels Ln′ in this iteration.

Another specific embodiment provides for the set of labels additionally to comprise the initial labels L1. The determination of (n+1)th labels in the nth iteration is then performed on the basis of the set comprising the initial labels L1, the nth labels Ln and the nth predicted labels Ln′ in this iteration.

Another specific embodiment provides for the steps 141n, 142n, 143n of the iterative process to be performed repeatedly for as long as a quality criterion and/or termination criterion is not yet fulfilled. A quality criterion comprises for example the quality of the generated labels Ln+1 or a prediction quality of model M. A termination criterion comprises for example the exceeding or undershooting of a threshold value, in particular a number of iterations to be performed or a value for the change of the labels Ln+1 from one iteration to the next or a quality measure for the labels Ln+1. The assessment of the quality of the labels Ln+1 and/or of the prediction quality may be performed for example on the basis of a labeled reference sample of good quality. Alternatively, the quality may be assessed on the basis of confidences of the model M, which are output in addition to the predicted labels.

Another specific embodiment provides for the labels Ln+1 to be used, in particular following the iterative process, as labels L for data set D as training data, in particular as training sample.

Another specific embodiment provides for the determination 143n of (n+1)th labels Ln+1 to comprise the determination of optimal labels. The determination may be performed automatically for example using an algorithm. For this purpose, in particular the nth labels Ln and the nth predicted labels Ln′, and possibly the initial labels L1, are compared to one another, and the best currently existing labels Ln+1 are selected, or a suitable combination or fusion of the currently existing labels is performed. Alternatively, a manual method for determining optimal labels Ln+1 is also possible.

In step 143n, a selection of labels Ln+1 is made by determining labels. According to one specific embodiment, a suitable measure is used in order to determine a difference of the various label versions Ln and Ln′. A possible measure in a regression problem is in particular the use of the Euclidean distance in the vector space of the labels. It is possible to use for example the Hamming distance in order to determine the distance of classification labels.

Another specific embodiment provides for the generation 120 of the initial labels L1 for the unlabeled data to be performed manually or by a pattern recognition algorithm. Since a faulty generation of the labels is sufficient in this step, the generation 120 may be performed automatically [using] a classical non-trained pattern recognition algorithm, in particular with a recognition imprecision. In particular, it is also possible to use a method trained on another data set without adaptation to the current data set. Manual labeling is in principle also possible.

Another specific embodiment provides for the method to comprise further: discarding data of the unlabeled data set D, in particular prior to training 141n model M. The discarded data are then no longer taken into consideration in the current nth iteration, and in particular also in further, (n+1)th iterations. In particular, data may be discarded for which a respective nth predicted label Ln′ deviates from a respective nth label Ln.

Another specific embodiment provides for the determination of (n+1)th labels Ln+1 to comprise the calculation of an, in particular weighted, average value of labels from the set of labels. In the course of the iterations, the weights may be advantageously changed in such a way that with an increasing number of iterations the labels predicted by the trained model Mn increasingly have a greater share and the initial labels L1 increasingly have a lesser share in the (n+1)th labels Ln+1. This procedure may be applied in particular in a regression problem.

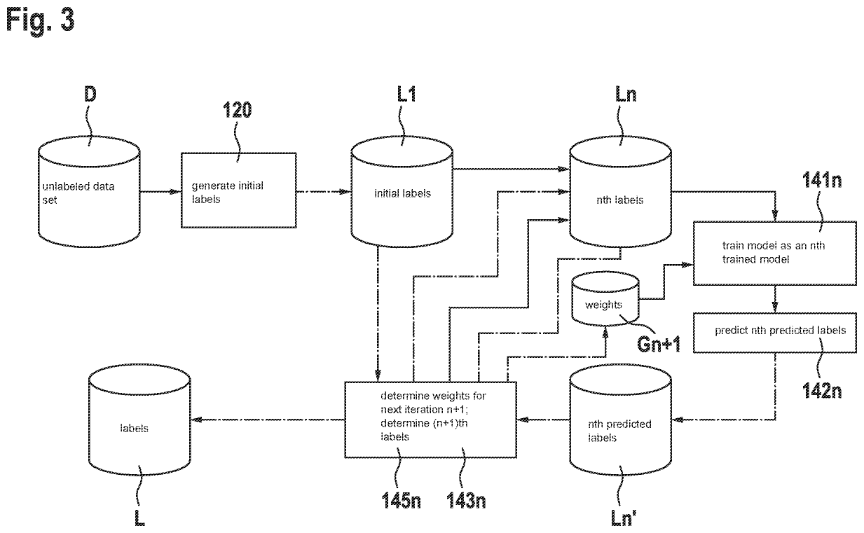

Another specific embodiment provides for the method to comprise further: determining weights for training the model and/or using weights for training the model. This aspect is now explained with reference to FIG. 3. According to the specific embodiment shown, a step 145n is performed in addition to the step 143n for determining labels Ln+1. In step 145n, weights Gn+1 are determined for the next iteration n+1. The weights Gn+1 are then used in the iteration n+1 when training model M. Advantageously, step 145n is performed in every iteration. For example, the determination 145n of the weights Gn+1 occurs by derivation of weights Gn+1 from a measure for the confidence of trained model Mn for the respective data of unlabeled data set D and/or from a measure for the confidence of the classical model for the respective data of data set D. It is advantageously possible to achieve the result that erroneously labeled data have a lesser effect on the recognition rate of the trained model. As an alternative or in addition to the confidences, it is also possible to perform a comparison of the labels and to include this in the determination of the weights.

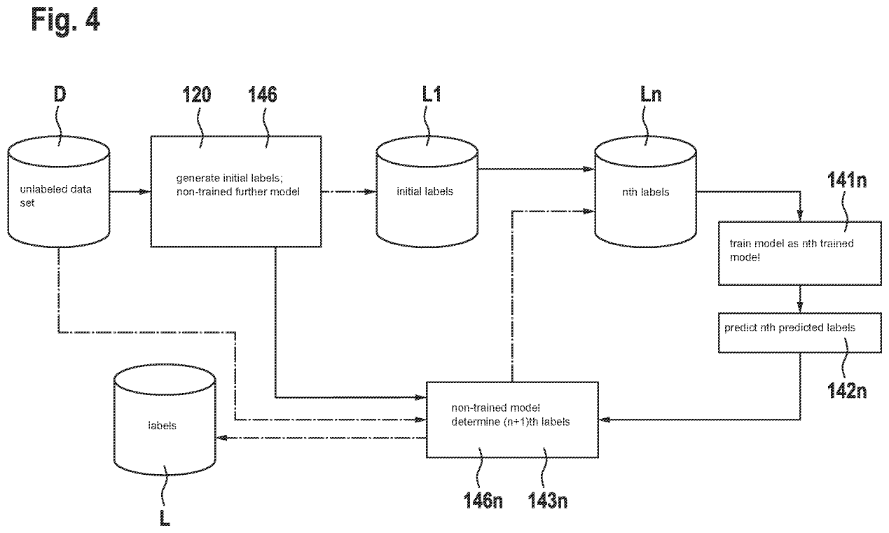

Another specific embodiment provides for steps of the method, in particular for the prediction 142n of nth predicted labels for the unlabeled data of the unlabeled data set by using the nth trained model and/or for the determination 143n of (n+1)th labels from a set of labels comprising the nth predicted labels to be carried out by using at least one further model. This specific embodiment is explained below with reference to FIG. 4. The specific embodiment shown provides for the trained model Mn to be part of a system for object recognition, and in particular for localization, abbreviated below as recognition system, comprising the at least one further model. For object recognition, the recognition system according to the specific embodiment shown uses a non-trained method 146, 146n, in particular by using tracking. According to the specific embodiment shown, the trained model Mn is a single-frame model so that the processing of data, in particular the prediction of labels Ln′, by the model is based on so-called single-frame processing, the processing of data at a specific point in time. This comprises for example the processing of an individual camera image or processing of an individual “sweep” of a lidar sensor at a specific point in time. This is a short period of time to be precise, since the recording of the data of an individual frame by the sensor requires a certain time. In this case, the model Mn does not use the time correlation of the data, that is, the recognition by the model Mn respectively uses the data of only one specific frame, while the data of frames before or after this frame are not used for the specific frame, but are processed independently of Mn. This time correlation is used exclusively by the non-trained component of the recognition system, for example by offline processing. The advantage of this combination is that the errors of the trained model are largely uncorrelated to the errors of the component of the offline processing utilizing the time characteristic and are thus able to balance out.

In the specific embodiment shown in FIG. 4, the improved labels Ln+1 resulting from an iteration n are also used for the training of the next iteration n+1.

A concrete example of an application for the specific embodiment shown in FIG. 4 is the environment perception for autonomous driving. For this purpose, a vehicle is equipped with at least one sensor, which detects static, i.e., stationary, and dynamic, i.e., movable objects in the surroundings of the vehicle. Advantageously, the vehicle may be equipped with multiple sensors, in particular with sensors of different modalities, for example with a combination of cameras, radar sensors, lidar sensors and/or ultrasonic sensors. This is then a multi-modal sensor set. The vehicle thus equipped is used in order to record the at first unlabeled sample of sensor data and to store these as data set D. The objective of the environment perception is to recognize the static and dynamic objects in the surroundings of the vehicle and to localize these and thus to generate a symbolic representation of these objects including the time characteristic. This symbolic representation is typically provided by partially time-dependent attributes of these objects, for example, attributes for the object type such as passenger car, cargo truck, pedestrian, bicycle rider, guardrail, object that can be driven over or cannot be driven over, lane marking and other attributes such as for example the number of axles, size, shape, position, orientation, speed, acceleration, state of the driving direction indicator and so on.

The trained model Mn for recognizing the objects and for determining relevant attributes in an individual camera frame, that is, in an individual image of a camera, may be for example a convolutional deep neural network. The trained model Mn for recognizing the objects on the basis of a point cloud, for example of an individual sensor sweep of a lidar sensor or of a scan of a radar sensor, may be for example likewise a convolutional deep neural network (CNN), which receives as input data a 2D projection of the point cloud, or, in the case of a 3D CNN, 3D convolutions are performed, the point cloud then being represented in a regular 3D grid. Alternatively, the trained model Mn may be a deep neural network having a PointNet or PointNet++ architecture, it being possible to process the point cloud directly.

This model Mn may be trained in step 141n on the basis of labels Ln. In the process, depending on the respective modality, a transformation of attributes may be performed. For example, in images of a camera, 3D positions of tracked objects may be projected into the camera image, that is, to 2D bounding boxes for example.

The objects detected in the individual frames may be tracked over time for example with the aid of a Kalman filter or an extended Kalman filter. To this end, an association of the objects may be performed on the basis of a comparison of their attributes, which correspond to the predictions at the single frame level 142n, to the predicted attributes of the objects already known in the previous time step, it being possible for the prediction of the already known objects to occur in the respective time of measurement. This prediction may occur on the basis of a physical movement model. Using the attributes recognized or estimated by trained model Mn on a single frame basis, which then correspond to predictions 142n, it is then possible to perform an update of the predicted attributes.

The non-trained further model 146 may also include methods for offline processing. For example, instead of a Kalman filter, it is possible to use a Kalman smoother such as for example the Rauch-Tung-Striebel filter.

Following the complete execution of the iterative process, a perception system is obtained that is made up of the non-trained tracking method and the at least one trained model Mn of the last iteration integrated therein. This system may be used as offline perception in order to label further sensor data that were not used in the iterative process. In this manner it is possible to generate further labeled samples automatically. If the offline tracking of this perception system is replaced by an online-capable tracking, that is, if for example the Rauch-Tung-Striebel smoother is replaced by the Kalman filter without smoother and the same trained models at the single-frame level continue to be used, then this online-capable perception system may be used in a vehicle for implementing the environmental perception of autonomous driving functions. In order to reduce the demands with respect to the required computing capacity, it is also possible to use trained single-frame models having reduced complexity for the online version of the perception system, which may be trained on the basis of the labels Ln generated in the last iteration of the iterative process and/or may be generated by compression and pruning from the trained model Mn of the last iteration.

The described application of the iterative process for implementing an offline perception and an online perception for autonomous driving functions may also be transferred analogously to other robots. For example, the iterative process may be applied to the implementation of the environment perception of a household robot, a patient-care robot, a construction site robot or a garden robot.

Another specific embodiment provides for method 100 to comprise a step for increasing a complexity of model M. Advantageously, it may be provided to increase the complexity of model M in the course of the iterations. Advantageously, there may be a provision to increase the complexity of model M in every iteration n, n=1, 2, 3, . . . N.

One specific embodiment may provide that at the beginning of the iterative process, that is, in the first iteration and in a certain number of further iterations relatively at the beginning of the iterative process, a model is trained, which is simpler with respect to the type of mathematical model and/or with respect to the complexity of the model and/or which contains a smaller number of parameters to be estimated within the scope of the training.

A concrete specific embodiment is explained by way of example for the application of method 100 to a classification problem by using the expectation maximization algorithm or EM algorithm. The EM algorithm is used to estimate the class-specific distributions of the data of data set D or the class-specific distributions of characteristics calculated from the data of data set D. The classification is based on maximizing the class-specific probability, for example by using the Bayes theorem. The EM algorithm may be used for example for estimating the parameters of Gaussian mixture distributions. When using Gaussian mixture distributions, it is possible to increase the model complexity by increasing the number of Gauss distributions that are estimated per mixture (and thus per class). Thus, in this example, a comparatively small number of Gauss distributions would be used at the beginning of the iterative process, and this number would be continuously increased in the course of the iterations.

Another concrete specific embodiment is explained by way of example for the application of the method by using a neural network, in particular a deep neural network (DNN) as the model. In this case, the model complexity may be changed via the architecture of the neural network. The greater the number of layers and the greater the number of neurons per layer, generally the higher will be the number of parameter estimated in training and thus the complexity of the neural network. In the concrete case, the type of linkages between the layers may also play a role.

In general, an increase of the complexity of the model, inter alia by increasing the number of the parameters of the model to be estimated in training, may improve the ability of the model to adapt to training data, i.e., to learn the distribution of the data. This advantageously results in a better recognition performance. In some cases, a high complexity of the model may also result in a poorer generalization capacity and in a so-called overfitting on the training data. While the recognition performance continues to rise with increasing model complexity on the training data, it drops on unseen test data. Overfitting may be all the more of a problem, the fewer data are available for the training.

In the method 100 disclosed herein, this effect may be significant since the labels L1, L2, L3, . . . used for the training are more faulty at the beginning of the iterative process than after repeated execution of iterations of the iterative process. As a result, the achieved recognition performance may be worse at the beginning of the process than the recognition performance at the end of the process. It may therefore be advantageous to achieve a good generalization capacity at the beginning of the process and to avoid overfitting. It may possibly also prove advantageous to accept a certain error rate due to a comparatively lower complexity of the model. In the course of the iterative process, the quality of the labels improves continuously so that more training data of better quality are available. After a certain quality of the labels has been achieved, it may then be advantageous to increase the complexity of model M continuously. In training data of a certain quality, a higher complexity of model M then generally also results in a further improvement of the recognition performance.

The error rate may be used for example as the criterion for determining a suitable complexity of the model in a specific step of the iterative method. In particular, a comparison of the error rate of the predicted labels Ln′ with the error rate of a specific training sample may be advantageous. If the error rate of the predicted labels Ln′ is worse, it may be advantageous to adapt the complexity of the model.

An exemplary use of the method will be explained below with reference to the example of a classification problem. In a classification problem, a label from a finite set of discrete labels is to be assigned to each data element of data set D. However, the method may also be applied to a regression problem, the labels in this case corresponding to specific continuous parameters, whose magnitude is to be estimated. A typical example for a classification problem is for example optical character recognition in text documents, for example in scanned text documents, on the basis of image data. For this purpose, the text document is usually subdivided into individual segments, an individual segment being assigned to an individual character, for example.

In step 120, the initial labels L1 are generated. The initial labels L1 have an error rate F1. In a classification problem, the error rate is defined for example as the share of the incorrect labels in the total number of data or labels.

One aspect of the iterative process is the improvement of the error rate of the predicted labels Ln′ by trained model Mn. Advantageously, Model Mi trained in an iteration step i achieves an error rate Fi′ in the application to unlabeled data set D, error rate Fi′ being better than error rate Fi of labels Li. In order to be able to achieve the improvement of the error rate in an iteration, that is, Fi′<Fi, the generalization capacity of the utilized model M may be a decisive factor. The generalization capacity of the model may be improved in particular via the increase of the complexity of the model. In addition, an improvement may also result from step 143n for determining (n+1)th labels Ln+1 from the set of labels comprising at least the nth labels Ln and the nth predicted labels Ln′. For this purpose, it is not necessary that Fi′<Fi in every individual iteration. An increase in the label quality and thus an improvement in the error rate is achieved by running through the iterative process multiple times. The process is ended for example when a saturation is reached at a specific remainder error rate.

The improvement of the error rate in a classification problem by training model M may be successful in particular when the label errors for each one of the classes are sufficiently rare so that the assignment of the class to specific characteristics of the respective data of this class, which may be derived from the set of all labeled data of the data set, is unequivocal.

The method may also be used in a regression problem. In a regression problem, the initial labels advantageously contain no systematic errors, so-called bias errors, which would be learned when training the model.

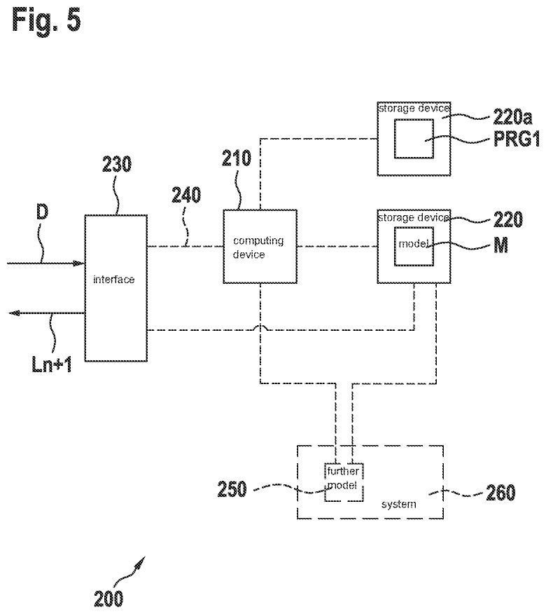

FIG. 5 finally shows a device 200, device 200 being designed to implement a method 100 in accordance with the described specific embodiments.

Device 200 comprises a computing device 210 and a storage device 220, in particular for storing a model, in particular a neural network. Device 210 in the example comprises an interface 230 for an input and an output of data, in particular for an input of the data of data set D and/or of initial labels L1 and for an output of labels Ln+1. Computing device 210 and storage device 220 and interface 230 are connected via at least one data line 240. Computing device 210 and storage device 220 may be integrated in a microcontroller. Device 200 may also be designed as a distributed system in a server infrastructure.

The specific embodiments provide for the computing device 210 to be able to access a storage device 220a, on which a computer program PRG1 is stored, the computer program PRG1 comprising computer-readable instructions, in the execution of which by a computer, in particular by computing device 210, the method 100 is implemented in accordance with the specific embodiments.

Another specific embodiment provides for device 200 to comprise at least one further model 250, the further model 250 being developed as part of a system 260 for object recognition.

Further specific embodiments relate to a use of method 100 according to the specific embodiments and/or of a device 200 according to the specific embodiments and/or of a computer program PRG1 according to the specific embodiments and/or of a computer program product according to the specific embodiments for generating training data for training a model, in particular a neural network.

Further specific embodiments relate to a use of labels Ln+1 for a data set D, in particular a data set D Ln+1 labeled with labels Ln+1, the labels Ln+1 having been generated using a method 100 according to the specific embodiments and/or using a device 200 according to the specific embodiments and/or using a computer program according to the specific embodiments and/or using a computer program product PRG1 according to the specific embodiments, in training data comprising the data set D for training a model, in particular a neural network.

Further examples of applications: medical image recognition and biometric person recognition

Method 100 and/or the labels Ln+1 generated using method 100 may be used in particular in systems for pattern recognition, in particular object detection, object classification and/or segmentation, in particular in the area of medical image recognition, for example the segmentation or classification of medical images, and/or in the area of autonomous or partially autonomous driving and/or in the area of biometric person recognition. The application is elucidated below with reference to two independent examples, on the one hand the classification of medical disorders on the basis of x-ray images, computer tomography images (CT) or magnetic resonance tomography images (MRT) and secondly the localization of faces in images as an element of a biometric system for the verification or identification of persons.

The method may be applied in these examples in that first a sample of images of the respective domain is recorded, which represents the at first unlabeled data set D. Thus one obtains for example a sample of CT images of a specific human organ, and in the second example a sample with photographs of faces. In the case of the images of faces, it may be advantageous to use video sequences instead of individual, mutually independent photographs, because the method according to FIG. 4 may then be used with tracking over time.

The step 120, the generation of initial, faulty labels, may be performed in the two application examples by comparatively simple heuristic methods in order to obtain initial labels of a segmentation and/or classification of the images. A concrete example is the segmentation at the pixel level on the basis of a simple threshold value of the respective brightness and/or color values and/or the rule-based classification on the basis of the distribution of all brightness or color values of the entire and/or segmented image. In the case of face localization, a rule-based segmentation of the image may be performed on the basis of typical skin tones. Alternatively, in the two cases of application, it is possible to perform manual labeling, it being possible to carry this out relatively quickly and cost-effectively due to the low requirements regarding the quality of the initial labels.

Model M, which is trained in the course of the iterative process and is used for the predictions, may be a convolutional deep neural network. In the application case of classification, it is possible to use one hot encoding of the output layer. For the application of facial recognition, which represents a special case of object detection, it is possible to use for example one of the deep neural network architectures YOLO (“you only look once”), R-CNN (“region proposal CNN”), fast R-CNN, faster R-CNN and/or retinanet for model M.

Since the generation of the initial labels is based on the color information, the generalization may be improved in that the color information is removed from the images at the beginning of the iterative process, that is, in that training and prediction in the iteration steps is performed exclusively on the basis of the gray-tone images. In the further course of the iterative process, in particular if portions of the images initially labeled falsely as “face” no longer result in false-positive predictions of the CNN, the color information may be added again so that the entire information may be used.

As an example for the realization of the label selection, in the application case of the classification of medical disorders, the selection may be made on the basis of confidences of the CNN. This may be implemented in such a way that at the beginning of the iterative process only those predicted labels are accepted which have a high confidence. The confidence may be determined for example in that in the use of one hot encoding the output value of the neuron of the output layer, which corresponds to the winner class, is regarded as confidence.

In the application case of the localization of faces in images, the method according to FIG. 4 may be combined with tracking over time if video sequences exist in data set D.

What is claimed is:

1. A method for generating labels for a data set, the method comprising the following steps:
providing an unlabeled data set including a number of unlabeled data;
generating initial labels for the data of the unlabeled data set;
providing the initial labels as nth labels where n=1; and
performing an iterative process, where an nth iteration of the iterative process includes the following steps for every n=1, 2, 3, . . . N:
training a model as an nth trained model using a labeled data set, the labeled data set being given by a combination of the data of the unlabeled data set with the nth labels;
predicting nth predicted labels for the unlabeled data of the unlabeled data set by using the nth trained model; and
determining (n+1)th labels from a set of labels including at least the nth predicted labels.

2. The method as recited in claim 1, wherein the set of labels includes the nth labels.

3. The method as recited in claim 1, wherein the steps of the iterative process are performed repeatedly for as long as a quality criterion and/or termination criterion is not yet fulfilled.

4. The method as recited in claim 1, wherein the determination of the (n+1)th labels includes a determination of optimal labels.

5. The method as recited in claim 1, wherein the generation of the initial labels for the unlabeled data is performed manually or by a pattern recognition algorithm.

6. The method as recited in claim 1, wherein the set of labels includes the initial labels.

7. The method as recited in claim 1, wherein the method further comprises:
discarding data of the unlabeled data set prior to training the model.

8. The method as recited in claim 1, wherein the determination of the (n+1)th labels includes a calculation of a weighted, average value of labels from the set of labels.

9. The method as recited in claim 1, wherein the method comprises:
determining weights for training the model and/or using weights for training the model.

10. The method as recited in claim 1, wherein, the predicting of nth predicted labels for the unlabeled data of the unlabeled data set by using the nth trained model and/or the determining of the (n+1)th labels from the set of labels including at least the nth predicted labels, is carried out by using at least one further model.

11. The method as recited in claim 1, wherein the method further comprises:
increasing a complexity of model.

12. A device configured to generate labels for a data set, the device configured to:
provide an unlabeled data set including a number of unlabeled data;
generate initial labels for the data of the unlabeled data set;
provide the initial labels as nth labels where n=1; and
perform an iterative process, where an nth iteration of the iterative process includes the following for every n=1, 2, 3, . . . N:
train a model as an nth trained model using a labeled data set, the labeled data set being given by a combination of the data of the unlabeled data set with the nth labels;
predict nth predicted labels for the unlabeled data of the unlabeled data set by using the nth trained model; and
determine (n+1)th labels from a set of labels including at least the nth predicted labels.

13. The device as recited in claim 12, wherein the device includes a computing device and a storage device configured to store the model, the model being a neural network.

14. The device as recited in claim 12, wherein the device further comprises at least one further model, the further model being developed as part of a system for object recognition.

15. A non-transitory computer-readable storage medium on which is stored a computer program for generating labels for a data set, the computer program, when executed by a computer, causing the computer to perform the following steps:
providing an unlabeled data set including a number of unlabeled data;
generating initial labels for the data of the unlabeled data set;
providing the initial labels as nth labels where n=1; and
performing an iterative process, where an nth iteration of the iterative process includes the following steps for every n=1, 2, 3, . . . N:
training a model as an nth trained model using a labeled data set, the labeled data set being given by a combination of the data of the unlabeled data set with the nth labels;
predicting nth predicted labels for the unlabeled data of the unlabeled data set by using the nth trained model; and
determining (n+1)th labels from a set of labels including at least the nth predicted labels.

16. The method as recited in claim 1, wherein the method is used for generating training data for training a neural network.

17. The method as recited in claim 1, wherein the generated labels are used with training data including the data set for training a neural network.
